(19) United States
(12) Patent Application Publication
(10) Pub. No.: US 2013/0175743 A1
(43) Pub. Date: Jul. 11, 2013

(54) SCRAPER BLADE CUSHION

(71) Applicants: Aaron T. GIBBS, Easton, PA (US); Leroy C. Williams, Hellertown, PA (US)

(72) Inventors: Aaron T. GIBBS, Easton, PA (US); Leroy C. Williams, Hellertown, PA (US)

(21) Appl. No.: 13/346,799

(22) Filed: Jan. 10, 2012

(51) Int. Cl. F16F 7/00; B65G 45/16

(52) U.S. Cl. 267/136

(57) ABSTRACT

A cushion for a scraper blade may comprise: a support plate having one or more members for engaging a support; a mounting plate opposite the support plate having a first end to which a scraper blade is mountable and having a second end remote from the first end; and a resilient cushioning material between and adhering to the support plate and the mounting plate. The cushion may further include one or more springs extending between the support plate and the mounting plate, or the resilient cushioning material surrounding the one or more springs, or the mounting plate having holes filled by the resilient cushioning material, or the second end of the mounting plate being formed to extend towards the support plate, or a combination thereof.

The present invention relates to a cushion and, in particular, to a cushion suitable for use with a scraper blade or other device.

Scraper blades bear against conveyor belts to remove material being carried thereon and/or to clean unwanted material therefrom. While conveyor belts are generally smooth, seams and clips, and other irregularities, as well as materials adhering to the conveyor belt that are desired to be removed from the belt so as to maintain its proper functioning, create irregularities that can jar and/or shock conveyor scraper blades in their operation, and can in turn jar and/or shock the blade support and or tensioner that supports the scraper blade, and possibly cause damage thereto.

To reduce and/or prevent damage to the scraper blade and/or to the support and/or tensioner therefor, it is desirable that a cushioning arrangement be provided so that damage to the scraper blade, its support, and/or tensioner may be reduced, if not avoided.

FIGS. 1 and 1A are a perspective view and a side view, respectively, of an example prior art cushion 900 for a scraper blade. Prior art scraper blade cushion 900 includes a blade support 910 to which a scraper blade is attached, e.g., by pins and/or bolts passing through the scraper blade and holes 912 of blade support 910, and a bolt plate 920 that includes threaded studs 930 that are attached to the blade support and tensioner and secured thereto by nut 932, lock washer 934 and flat washer 936. Blade support 910 is a generally flat plate as is mounting plate 920. Blade support 910 is joined to bolt plate 920 by a resilient cushioning material 940 that adheres to the generally flat surfaces of blade support 910 and bolt plate 920. Even though blade support 900 is rugged and performs well, with use, vibration and absorption of impacts over time, cushioning material 940 can tend to be torn loose or to separate from blade support 910 and/or bolt plate 920, thereby resulting in the need to replace prior art cushion 900.

Applicant believes that it would be beneficial to provide an improved cushion assembly that can exhibit improved resistance to separation of the cushioning material from the blade mounting plate and/or the cushion bolt plate.

Accordingly, a scraper blade cushion may comprise: a support plate having one or more members for engaging a support; a mounting plate opposite the support plate and having an end formed to extend towards the support plate; one or more springs between the support plate and the mounting plate; and a resilient cushioning material between and adhering to the support plate and the mounting plate and surrounding at least the one or more springs.

According to another aspect, a cushion for a scraper blade may comprise: a support plate having one or more threaded members for engaging a support; a mounting plate opposite the support plate and having an end formed to extend towards the support plate; and a resilient cushioning material between and adhering to the support plate and the mounting plate and surrounding at least the formed end of the mounting plate.

According to another aspect, a cushion for a scraper blade may comprise: a support plate having one or more threaded members for engaging a support; a mounting plate opposite the support plate and having a first end to which a scraper blade is mountable and having a second end remote from the first end; and a resilient cushioning material between and adhering to the support plate and the mounting plate and surrounding at least the second end of said mounting plate.

According to a further aspect, a cushion for a scraper blade may comprise: a support plate having one or more threaded members for engaging a support; a mounting plate opposite the support plate and having one or more holes therethrough; and a resilient cushioning material between and adhering to the support plate and the mounting plate, wherein the resilient cushioning material substantially fills the holes through the mounting plate.

### BRIEF DESCRIPTION OF THE DRAWING

The detailed description of the preferred embodiment(s) will be more easily and better understood when read in conjunction with the FIGURES of the Drawing which include:

FIGS. 1 and 1A are a perspective view and a side view, respectively, of a prior art cushion for a scraper blade;

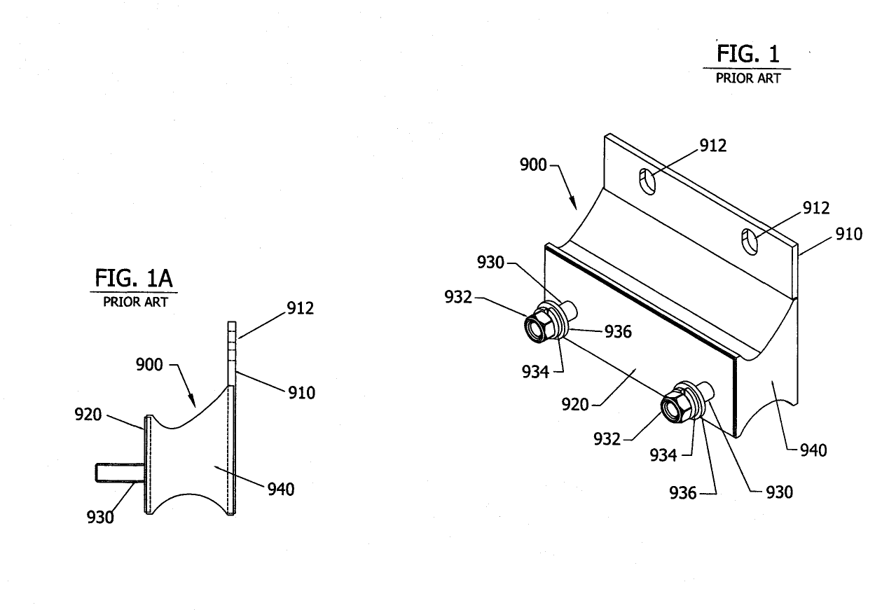

FIG. 2 is a perspective view of an example embodiment of a cushion assembly of a sort suitable for supporting a scraper blade, FIG. 2A is a front view thereof, and FIG. 2B is a side cross-sectional view thereof;

FIG. 3 includes FIG. 3A which is front view and FIG. 3B which is a side view of a blade mounting plate thereof;

FIG. 4 includes FIG. 4A which is a front view and FIG. 4B which is a side view of a cushion mounting plate or cushion support plate thereof, and

FIG. 5 is a perspective view of the example embodiment of a cushion assembly attached to and/or mounted to a blade support and tensioning device, and having a scraper blade attached and/or mounted thereto.

In the Drawing, where an element or feature is shown in more than one drawing figure, the same alphanumeric designation may be used to designate such element or feature in each figure, and where a closely related or modified element is shown in a figure, the same alphanumerical designation primed or designated “a” or “b” or the like may be used to designate the modified element or feature. According to common practice, the various features of the drawing are not to scale, and the dimensions of the various features may be arbitrarily expanded or reduced for clarity, and any value stated in any Figure is given by way of example only.

### DESCRIPTION OF THE PREFERRED EMBODIMENT(S)

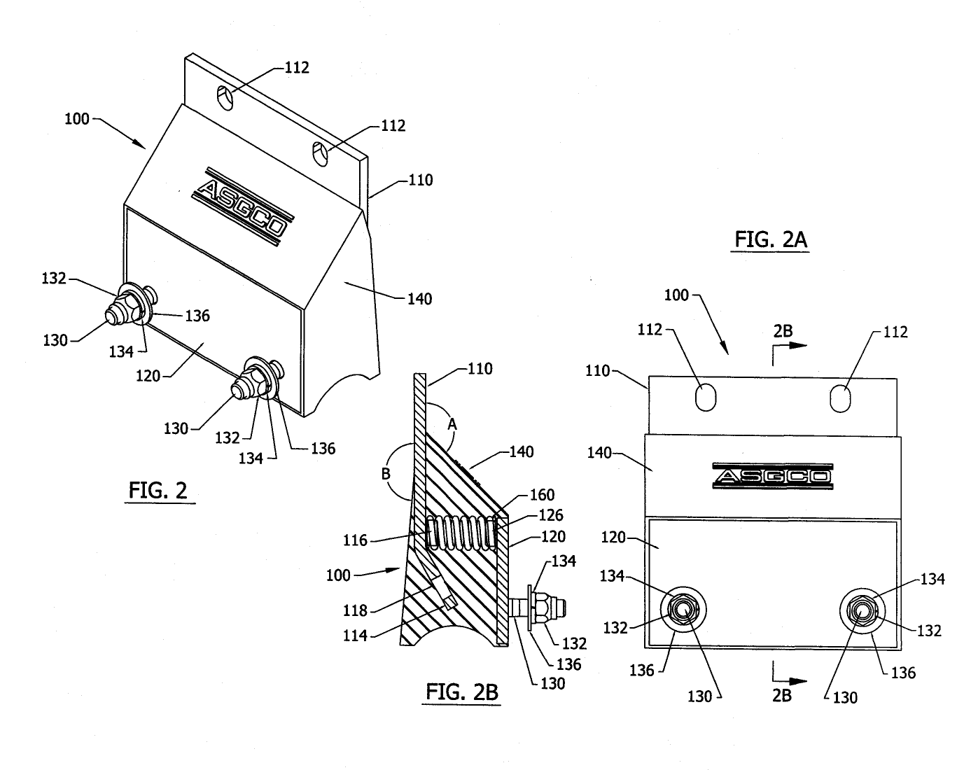

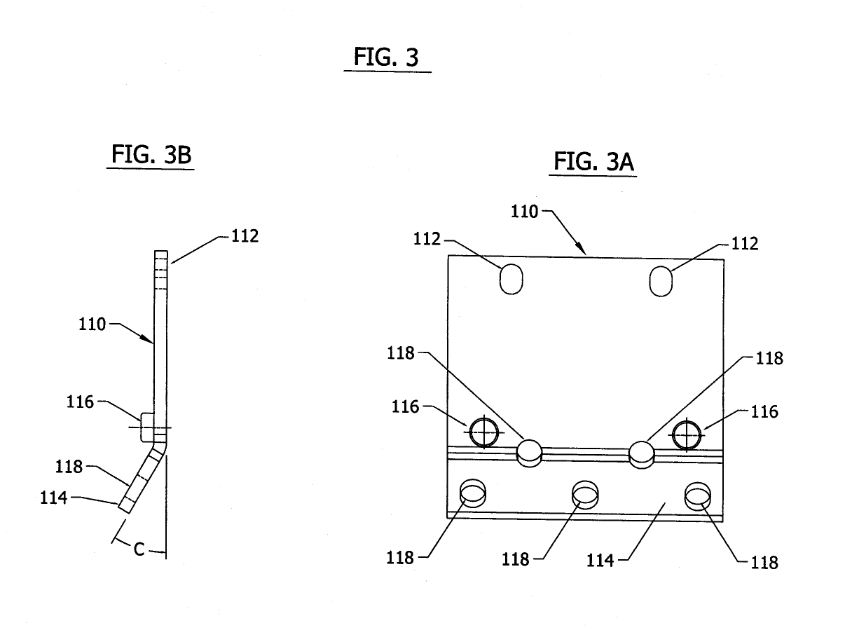

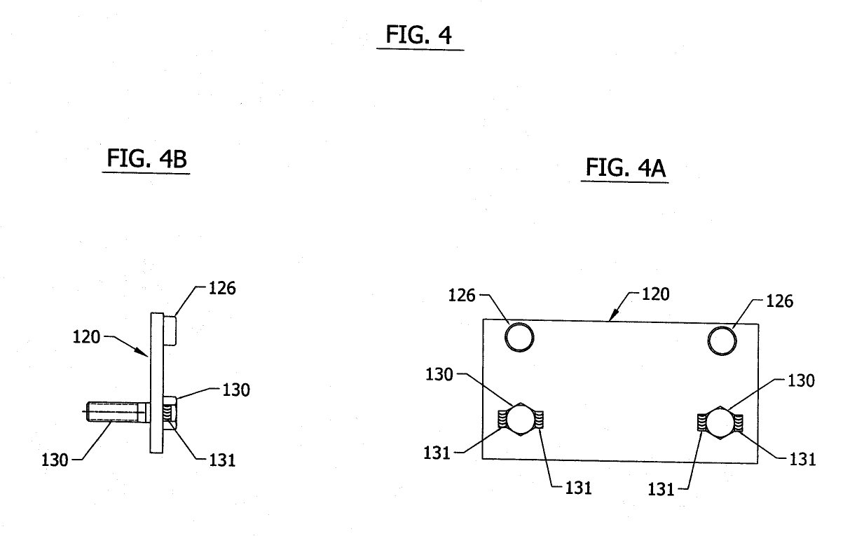

The preferred embodiment(s) are described in relation to FIG. 2 which is a perspective view of an example embodiment of a cushion assembly 100 of a sort suitable for supporting a scraper blade, FIG. 2A is a front view thereof; and FIG. 2B is a side cross-sectional view thereof, as well as in relation to FIG. 3A which is front view and FIG. 3B which is a side view of a blade mounting plate 110 thereof; and FIG. 4A which is a front view and FIG. 4B which is a side view of a cushion mounting plate 120 or cushion support plate 120 thereof. While cushion assembly 100 is described herein in the context of supporting and cushioning a scraper blade, e.g., of a sort utilized in a conveyor belt system, cushion 100 may be employed in other contexts, e.g., for supporting and cushioning other working devices.

Blade cushion assembly 100 comprises a blade mounting plate 110 to which a scraper blade and/or blade tip is attached and/or mounted, e.g., by pins or bolts or other hardware engaging one or more holes 112 of mounting plate 110, a cushion support plate 120 by which scraper blade cushion assembly 100 is attached and/or mounted to a support structure, e.g., a torsioned or tensioned bar or other support, and a resilient cushioning material 140 that adheres to and connects blade mounting plate 110 and support plate 120 wherein the resiliency thereof permits limited relative motion therebetween.

Blade cushion assembly 100 comprises one or more springs 160 interior to cushioning material 140 and bearing against both blade mounting plate 110 and cushion support plate 120. Springs 160 thus provide for transmission of at least a part of any shock or impact to the scraper blade or tip that is attached and/or mounted to blade mounting plate 110 to support plate 120. Springs 160 thus allow blade mounting plate 110 to move relative to support plate 120 for the attenuation of shock and/or impact loads, as well as to allow movement of the scraper blade attached to and/or mounted to cushion assembly 100 relative to the conveyor belt against which it bears so as to reduce the likelihood of damage to the conveyor belt, e.g., due to shock and or impact resulting from seams, joints, adhered materials, and other irregularities associated with the conveyor belt.

Cushioning material 140 preferably envelopes and surrounds springs 160 and adheres to blade mounting plate 110 and to support plate 120 to also attenuate any shock and/or impact loads. Preferably, the shape into which cushioning material 140 is molded extends to provide a relatively greater area of attachment to mounting plate 110 and to cushion support plate 120. For example, cushioning material 140 preferably extends to cover the upper end of support plate 120 and to extend therefrom at an angle A so as to extend relatively closer to the holes 112 of mounting plate 110, thereby to increase the area of adhesive connection between cushioning material 140 and the interior surface of mounting plate 110. In addition, cushioning material 140 is preferably molded to surround at least the remote end 114 of mounting plate 110, including around the edges thereof, and preferably to define an angle B so as to extend further along the exterior surface of mounting plate 110 toward holes 112, thereby to increase the area of adhesive connection between cushioning material 140 and the exterior surface of mounting plate 110. Similarly, cushioning material 140 is preferably sized and shaped to extend over at least some of the edges, and preferably to extend over all four edges, of support plate 120, thereby to increase the area of adhesive connection between cushioning material 140 and support plate 120.

The resilient nature of cushioning material 140 also allows blade mounting plate 110 to move relative to cushion support plate 120 for the attenuation of shock and/or impact loads, as well as to allow movement of the scraper blade attached to and/or mounted to cushion assembly 100 relative to the conveyor belt against which it bears so as to reduce the likelihood of damage to the conveyor belt, e.g., due to shock and or impact resulting from seams, joints, adhered materials, and other irregularities associated with the conveyor belt. In addition, cushioning material 140 also preferably surrounds at least a substantial part of blade mounting plate 110, e.g., the part remote from holes 112 by which a scraper blade or tip is attached and/or mounted thereto, and cushion support plate 120, and may also at least partially surround a part of support plate 120.

Because the scraper blade or tip is attached or mounted via holes 112 to blade mounting plate 110, shock and/or impact loads applied to the scraper blade or tip are transmitted essentially without attenuation to blade mounting plate 110, and via blade mounting plate 110 to springs 160 and cushioning material 140, and so the interface between blade mounting plate 110 and cushioning material is preferably more robust to resist any separating forces resulting from such shock and/or impact loads.

As best seen in FIG. 3, blade mounting plate 110 is formed including a generally rectangular metal plate. The remote end 114 of blade mounting plate 110 is preferably formed, e.g., by bending or forging or stamping to an angle C, in a direction to become more deeply embedded into cushioning material 140, thereby to improve the ability of cushioning material 140 to resist separating from mounting plate 110. In addition and/or alternatively, mounting plate 110 preferably has a plurality of holes 118 that fill with cushioning material 140 when cushion assembly 100 is molded (as described below), thereby to improve the integrity of cushioning material 140 as an integral mass and the ability of cushioning material 140 to resist separating from mounting plate 110.

As best seen in FIG. 4, cushion support plate 120 is formed including a generally rectangular metal plate 120 on which is provided a stud, 130, preferably a threaded stud 130, extending generally perpendicularly therefrom for receiving hardware, e.g., washers 134, 136, and nuts 132, thereon. Threaded studs 130 are preferably provided, e.g., by a bolt or other threaded fastener 130 that resides in and passes through a hole in plate 120, whether or not being threaded therein, wherein the threaded shank of the bolt or fastener 130 extends through plate 120 to provide the threaded stud 130. The head of bolt 130 is preferably welded 131 to support plate 120 so as to be permanently affixed thereto and so as to not rotate relative to plate 120, thereby to facilitate the placing, tightening and loosening of hardware, e.g., washers 134, 136, and nuts 132, thereon. Alternatively, threaded studs 130 may be threaded studs that are welded to and/or threaded into support plate 120.

In addition, mounting plate 110 preferably has one or more locating posts 116 of like number to the number of springs 160 and support plate 120 preferably has one or more locating posts 126 of like number to the number of springs 160, so that the respective ends of springs 160 are positively located in desired positions relative to mounting plate 110 and support plate 120 when assembled into cushion assembly 110. Locating posts 116, 126 may be formed in plates 110, 120, e.g., by stamping or forging, into plates 110, 120, or may be formed of separate disks that are affixed, e.g., by welding, to plates 110, 120, or may be provided by the heads of short bolts 126 or other fasteners having a short threaded shank that threads into a hole (not visible) in plates 110, 120.

When springs 160 are placed in position with their opposite ends over locating posts 116, 126, plates 110 and 120 are assisted thereby to be located in the desired relative positions they will have in cushion assembly 100. Springs 160 may be affixed to locating posts 116, 126, e.g., by welding, or may simply be placed over the posts and held in place by cushioning material 140 when cushion assembly 100 is molded.

Assembly of scraper blade cushion 100 may be performed as follows: After obtaining a mounting plate 110, a support plate 120 and one or more springs 160, mounting plate 110 and support plate 120 are placed in a fixture in their final relative positions with the respective ends of one or more springs 160 on locating posts 116, 126, so that all of mounting plate 110, support plate 120 and springs 160 are in their respective desired positions relative to each other. A mold defining the shape of the volume that will be filled with cushioning material 140 is placed over the positioned mounting plate 110, support plate 120 and springs 160 in a position to define the volume in the desired position of cushioning material 140 relative to mounting plate 110 and support plate 120. Cushioning material 140 is poured or injected into the mold therefor to fill the mold and is then allowed to harden and/or cure to adhere to mounting plate 110, support plate 120 and springs 160. For a thermoplastic material, the heated material is put into the mold and is then allowed to cool; for a reactive material, the material is mixed, poured or injected to fill the mold and then allowed to cure, e.g., cross-link, therein, whether at ambient temperature or at an elevated temperature. Finally, the mold is removed and cushion 100 is completed. Some trimming of or otherwise removing mold remnants may be required to provide the final shape of cushion 100.

In one example embodiment of cushion assembly 100, plate 110 and plate 120, are steel, and preferably are stainless steel, and more preferably are type 304 stainless steel or an equivalent. Threaded stud 130 and hardware 132, 134, 136 are steel, and preferably are grade 5 zinc-plated steel, but could be stainless steel. Compression springs 160 are preferably of spring steel. Cushioning material 140 is preferably a resilient rubber matrix material, e.g., an EPDM rubber matrix exhibiting about 60 durometer, Shore A hardness. It is understood that different materials, different springs and different resilient materials may be employed to provide different stiffness and cushioning characteristics.

Therein, cushion assembly 100 is about 6 inches (about 15.2 cm) high, about 5⅝ inches (about 14.3 cm) wide, and about 2⅜ inches (about 6 cm) thick. Mounting plate 110 thereof is, e.g., about 5 5/16 inches (about 13.5 cm) high by about 5⅝ inches (about 14.3 cm) wide and about ¼ inch (about 6.4 mm) thick, and angle C is about 30°. Support plate 120 thereof is, e.g., about 2¾ inches (about 7 cm) high by about 5 7/16 inches (about 13.8 cm) wide and about ¼ inch (about 6.4 mm) thick, and threaded studs 130 have a ⅜-16 UNC thread and extend about 1¼ inches (about 3.2 cm) from support plate 120. Typical springs 160 have an outer diameter of about ¾ inch (about 1.9 cm) and a length of about 1½ inches (about 3.8 cm), and having a spring rate of about 48 pounds/inch (about 8.4 N/mm). Cushioning material 140 is molded to about 5⅝ by 4 11/16 by 2⅜ inches (about 14.3 by 11.9 by 6 cm) in size and defines an angle A of about 135° and an angle B of about 175° and cushioning material 140 typically extends over the edges of plates 110, 120 by about 1/16 to 3/32 inch (about 1.6 to 2.4 mm) and surrounds end 114 of plate 110.

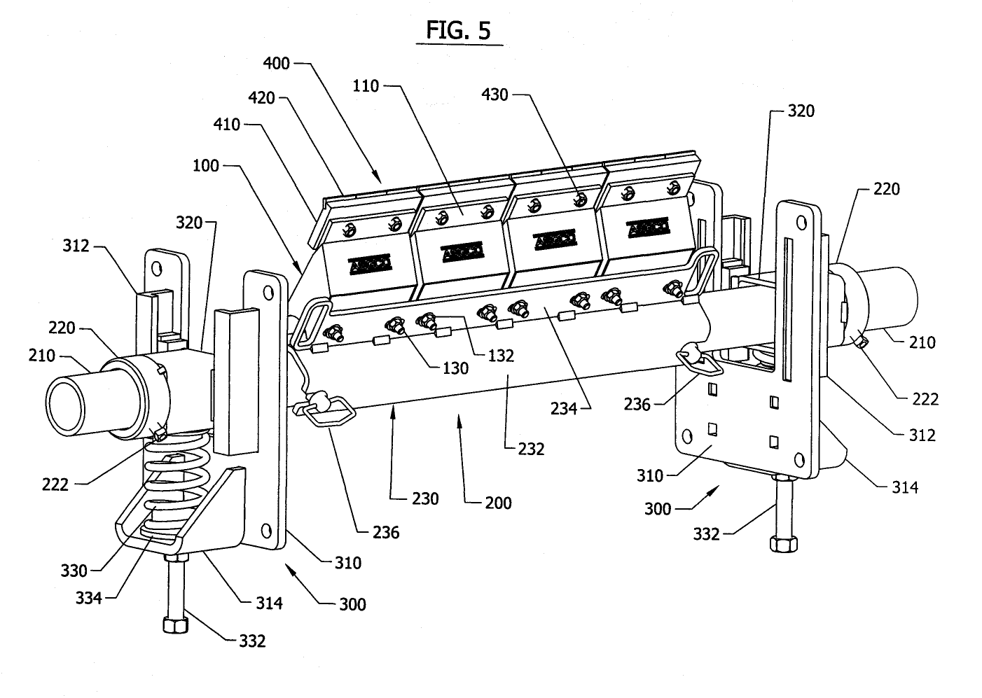

FIG. 5 is a perspective view of the example embodiment of one or more cushion assemblies 100 that are attached to and/or mounted to a blade support 200 and tensioning device 300, and that has one or more scraper blades 400 attached and/or mounted thereto. In particular, each example scraper blade cushion 100 may be mounted to blade support 200 by its threaded studs 130 passing through holes in flange 234 of support 200 and being secured thereto by lock nuts 132 (e.g., with washers 134, 136) on stud 130 of cushion assembly 100. Each example scraper blade 400 is mounted to a respective cushion 100 by bolts or pins 430 that pass through holes 112 of blade mounting plate 110 of cushion 100 and are secured therein by respective nuts 430, typically lock nuts 430, with lock appropriate lock and flat washers.

Scraper blade 400 typically includes a blade body 410 that is shaped and/or formed to provide support for a working edge 420 or blade tip 420 along one end thereof and to provide a base along an opposing end thereof. Typically blade tip 420 may have opposing surfaces that are at an acute angle so as to present a relatively thin or sharp edge 420 to the conveyor belt, typically so that one surface of blade tip 420 may serve as a ramp-like surface for removing material from the conveyor belt. Body 410 of scraper blade 400 may be steel and the blade edge or tip 420 thereof may be of a hard material, e.g., tungsten carbide, or of one or more resilient materials, such as a rubber, UHMW urethane or other plastic material, so as to give blade 400 the desired characteristics, e.g., of stiffness, flexibility and/or wear.

Scraper blade 400 may have a base including a member of metal or another relatively rigid material for supporting the studs or bolts 430 for mounting scraper blade 400 to scraper blade cushion assembly 100. Alternatively, the base of scraper blade 400 may be formed into the desired shape for supporting bolts or studs 430 embedded therein or for providing mounting features, e.g., one or more holes, slots, ridges, grooves, posts, and the like, by which blade 400 may be mounted to scraper blade cushion 100.

Blade support 200 comprises a support bar 210 that is mounted transversely to and spaced away from a movable conveyor belt and that is rotatable about its longitudinal axis. Support bar 210 is typically rotatably supported at each of its ends by a sleeve or bearing or other rotatable device 320 that is mounted to the structure supporting the conveyor or to another suitable fixed support. Support bar 210 is held in position in sleeves 320 by respective annular collars 220, typically with one collar 220 at each end of support bar 210 and secured thereat by a fastener, e.g., by a set bolt 222 or pin 222 or clip or other device.

One or both of the rotatable supports 320 typically and preferably is or includes a tensioning device 300 that applies a force (or torque) to support bar 210 in a direction that biases support bar 210 to move (or rotate) in a direction that moves the working blade tip 420 of scraper blade 400 toward and into contact with the conveyor belt. As a result, the contact force or pressure of scraper blade 400 against the conveyor is established and maintained by tensioning device 300 at a desired value for scraper blade 400 to remove material from the conveyor belt.

Tensioning device 300 typically includes a mounting base 310 which is mounted to a conveyor support structure or other suitable fixed structure and which has various holes or other openings through which mounting hardware may be provided. In example tensioner 300, mounting base 310 has a pair of opposing guides 312 between which support bar sleeve 320 is retained for translational movement, e.g., vertically, in guides 312, either upward in response to force applied by tensioning spring 330 or downward in response to the weight of support 200, cushion 100 and blade 400 and force generated by the conveyor belt (not shown). Support sleeve 320 typically has a pair of outwardly extending flanges that ride in the opposing grooves defined by base 310 and guides 312.

Spring 330 abuts a movable spring base 334 (shown as resting against support flange 314) of mounting base 310 which may have a post or other projection for positioning the lower end of tensioning spring 330 on flange 314. Support sleeve 320 may have a post or other projection for positioning the upper end of tensioning spring 330 on sleeve 320. A threaded adjustment bolt 332 is threaded in a threaded hole in support flange 314 wherein rotating adjustment bolt in one direction advances bolt 332 upward thereby to move spring base 334 upward tending to compress spring 330 and to increase the force with which blade 400 is pressed against the conveyor belt. Rotating bolt 332 in the opposite direction allows spring base 334 to move downward, thereby allowing spring 330 to expand and lessen the force of blade 400 against the conveyor belt.

Support 200 includes a radially extending longitudinal flange 234 having holes therein for receiving the studs 130 of one or more blade cushions 100 therethrough and being held thereon by lock nuts 132, wherein the one or more blade cushions 100 support one or more blades 400. Longitudinal flange 234 may be welded or otherwise attached to support rod 210, or may be part of an optional cartridge 230.

Optionally, support 200 may include a cartridge 230 that mounts to support rod 210 and that includes the radially extending longitudinal flange 234 having holes therein for receiving one or more blade cushions 100 thereon. Cartridge 230 may include a base 232 having a shape generally conforming to the shape of support rod 210, e.g., base 232 of cartridge 320 may be generally semi-cylindrical in shape so as to fit against the cylindrical shape of a tubular support rod 210. Base 232 typically has flange 234 attached, e.g., welded, thereto. Flange 234 may optionally have openings or loops or other features, e.g., at the ends thereof, for serving as handles by which cartridge 230 may be more easily carried, installed and removed. Typically, cartridge 230 may be referred to as a cartridge 230 whether referring to the assembly of base 232 and flange 234 or to the assembly of base 232 and flange 234 with one or more blade cushions 100 and/or one or more blades 400 assembled thereto.

Cartridge base 232 typically has opposing slots, holes or other openings located about 180° apart radially that correspond to radially aligned holes through support rod 210 for receiving pins 236 therethrough for removably securing cartridge 230, and the cushions 100 and blades 400 mounted thereto, to support rod 210. Example pins 236 preferably have a D-ring for assisting in their handling, insertion and removal, and preferably are secured in place by a snap-on clip, cotter pin or other clip, a detent, a spring-biased ball detent, or other locking device.

This arrangement with cartridge 230 advantageously permits all of blade cushions 100 and blades 400 to be installed on and removed from support rod 210 as a unit, i.e. as a cartridge, at the same time, which minimizes the time required for replacing blades on the conveyor, e.g., the “down time” of the conveyor, and also allows maintenance personnel to replace blades 400 and/or cushions 100 on cartridge 230 without removing support rod 210. Moreover, this work may be performed away from the conveyor belt, and so the replacement of blades 400 and/or cushions 100 may be performed in a safer and more convenient location, e.g., in a work shop or maintenance facility, and where time pressure to quickly replace the blades to minimize conveyor “down time” is not present.

In the foregoing example, support cartridge 230 may be a RAZOR-BACK™ blade cartridge available from ASGCO Manufacturing Company of Allentown, Pa., tensioner 300 may be an AIR-SHOC™ or SPRING-SHOC™ tensioner available from ASGCO Manufacturing Company, and scraper blade 400 may be a type RAZORBACK MDX™ scraper blade available from ASGCO Manufacturing Company. An example of a tensioner 300 is described in U.S. patent application Ser. No. 12/643,271 entitled “Reversible Tensioning Device, as for a Conveyor” filed by Adam Zehnder et al on Dec. 21, 2009 and published as U.S. Patent Publication No. 2010/0170127 on Oct. 28, 2010, which is hereby incorporated herein by reference in its entirety.

A cushion 100 for a scraper blade may further comprise: a support plate 120 having one or more members 130 extending from a first side thereof for engaging a support; a mounting plate 110 opposite a second side of support plate 120, mounting plate 110 having a first end to which a scraper blade is mountable and having a second end remote from the first end and formed to extend towards support plate 120; one or more springs 160 extending between support plate 120 and mounting plate 110; and a resilient cushioning material 140 between and adhering to support plate 120 and mounting plate 110, resilient cushioning material 140 surrounding at least one or more springs 160. Resilient cushioning material 140 may surround at least the second end of mounting plate 110. Mounting plate 110 may have one or more holes therethrough proximate the second end thereof, and resilient cushioning material 140 may substantially fill the holes through mounting plate 110. Support plate 120, mounting plate 110, or both may include one or more locating features for locating respective ends of one or more springs 160. Mounting plate 110 may have one or more holes proximate the first end thereof for receiving a scraper blade. Resilient cushioning material 140 may include: a rubber; or a plastic; or an EPDM rubber; or an EPDM rubber having a 60 durometer Shore A hardness. The one or more springs 160 may include two springs 160 each having one end located by a locating feature of mounting plate 110 and a second end located by a locating feature of support plate 120.

A cushion 100 for a scraper blade may further comprise: a support plate 120 having one or more threaded members 130 extending from a first side thereof for engaging a support; a mounting plate 110 opposite a second side of support plate 120, mounting plate 110 having a first end to which a scraper blade is mountable and having a second end remote from the first end and formed to extend towards support plate 120; and a resilient cushioning material 140 between and adhering to support plate 120 and mounting plate 110, resilient cushioning material 140 surrounding at least the formed second end of mounting plate 110. Mounting plate 110 may have one or more holes therethrough proximate the second end thereof, and wherein resilient cushioning material 140 substantially fills the holes through mounting plate 110. Cushion 100 may further comprise one or more springs 160 extending between support plate 120 and mounting plate 110. Resilient cushioning material 140 may surround one or more springs 160. Support plate 120, mounting plate 110, or both may include one or more locating features for locating respective ends of one or more springs 160. The one or more springs 160 may include two springs 160 each having one end located by a locating feature of mounting plate 110 and a second end located by a locating feature of support plate 120. Mounting plate 110 may have one or more holes proximate the first end thereof for receiving a scraper blade. Resilient cushioning material 140 may include: a rubber; or a plastic; or an EPDM rubber; or an EPDM rubber having a 60 durometer Shore A hardness.

A cushion 100 for a scraper blade may further comprise: a support plate 120 having one or more threaded members 130 extending from a first side thereof for engaging a support; a mounting plate 110 opposite a second side of support plate 120, mounting plate 110 having a first end to which a scraper blade is mountable and having a second end remote from the first end; and a resilient cushioning material 140 between and adhering to support plate 120 and mounting plate 110, resilient cushioning material 140 surrounding at least the second end of mounting plate 110. Mounting plate 110 may have one or more holes therethrough proximate the second end thereof, and resilient cushioning material 140 may substantially fill the holes through mounting plate 110. The second end remote from the first end of mounting plate 110 may be formed to extend towards support plate 120. Cushion 100 may further comprise one or more springs 160 extending between support plate 120 and mounting plate 110. Resilient cushioning material 140 may surround one or more springs 160. Support plate 120, mounting plate 110, or both may include one or more locating features for locating respective ends of one or more springs 160. The one or more springs 160 may include two springs 160 each having one end located by a locating feature of mounting plate 110 and a second end located by a locating feature of support plate 120. Mounting plate 110 may have one or more holes proximate the first end thereof for receiving a scraper blade. Resilient cushioning material 140 may include: a rubber; or a plastic; or an EPDM rubber; or an EPDM rubber having a 60 durometer Shore A hardness.

A cushion 100 for a scraper blade may further comprise: a support plate 120 having one or more threaded members 130 extending from a first side thereof for engaging a support; a mounting plate 110 opposite a second side of support plate 120, mounting plate 110 having a first end to which a scraper blade is mountable and having a second end remote from the first end, wherein mounting plate 110 may have one or more holes therethrough proximate the second end thereof; and a resilient cushioning material 140 between and adhering to support plate 120 and mounting plate 110, resilient cushioning material 140 surrounding at least the second end of mounting plate 110, and wherein resilient cushioning material 140 substantially fills the holes through mounting plate 110. The second end of mounting plate 110 may be formed to extend towards support plate 120. Cushion 100 may further comprise one or more springs 160 extending between support plate 120 and mounting plate 110. Resilient cushioning material 140 may surround one or more springs 160. Support plate 120, mounting plate 110, or both may include one or more locating features for locating respective ends of one or more springs 160. The one or more springs 160 may include two springs 160 each having one end located by a locating feature of mounting plate 110 and a second end located by a locating feature of support plate 120. Mounting plate 110 may have one or more holes proximate the first end thereof for receiving a scraper blade. Resilient cushioning material 140 may include: a rubber; or a plastic; or an EPDM rubber; or an EPDM rubber having a 60 durometer Shore A hardness.

As used herein, the term “about” means that dimensions, sizes, formulations, parameters, shapes and other quantities and characteristics are not and need not be exact, but may be approximate and/or larger or smaller, as desired, reflecting tolerances, conversion factors, rounding off, measurement error and the like, and other factors known to those of skill in the art. In general, a dimension, size, formulation, parameter, shape or other quantity or characteristic is “about” or “approximate” whether or not expressly stated to be such. It is noted that embodiments of very different sizes, shapes and dimensions may employ the described arrangements.

Although terms such as “up,” “down,” “left,” “right,” “front,” “rear,” “side,” “top,” “bottom,” “forward,” “backward,” “under” and/or “over,” and the like may be used herein as a convenience in describing one or more embodiments and/or uses of the present arrangement, the articles described may be positioned in any desired orientation and/or may be utilized in any desired position and/or orientation. Such terms of position and/or orientation should be understood as being for convenience only, and not as limiting of the invention as claimed.

While the present invention has been described in terms of the foregoing example embodiments, variations within the scope and spirit of the present invention as defined by the claims following will be apparent to those skilled in the art. For example, mounting plate 110 may have one or more studs or threaded studs for mounting a scraper blade thereto, and such studs may receive a cotter pin, safety wire, clip, lock nut and/or lock washer or other securing device for preventing loosening or release due to vibration or other unintended condition.

In addition, support plate 120 may have one or more studs, pins, flanges, posts or other features, or may extend beyond cushion material 140, for mounting blade cushion 100 to a blade support. Further, plate 120 may have a stud 130 that receives a cotter pin, safety wire, clip or other substitute for a lock nut 132 and/or lock washer 134 for preventing loosening or release due to vibration or other unintended condition.

Scraper blade cushion 100 may be employed with various shapes, sizes, types and kinds of scraper blades, and with various shapes, sizes, types and kinds of blade supports in different configurations and optionally employing different shapes, sizes, types and kinds of tensioning devices. One embodiment of cushion 100, for example, is suitable for use with type MDX RAZORBACK scraper blades available from ASGCO Manufacturing Company, Inc., located in Allentown, Pa.

Further, a cushion 100 may be employed for supporting and cushioning working devices other than a scraper blade, e.g., a roller, a brush, a roller brush and other devices usable with a conveyor belt or other apparatus.

Each of the U.S. Provisional Applications, U.S. patent applications, and/or U.S. patents identified herein are hereby incorporated herein by reference in their entirety, for any purpose and for all purposes irrespective of how it may be referred to herein.

Finally, numerical values stated are typical or example values, are not limiting values, and do not preclude substantially larger and/or substantially smaller values. Values in any given embodiment may be substantially larger and/or may be substantially smaller than the example or typical values stated.

What is claimed is:

1. A cushion for a scraper blade comprising:
a support plate having one or more members extending from a first side thereof for engaging a support;
a mounting plate opposite a second side of said support plate, said mounting plate having a first end to which a scraper blade is mountable and having a second end remote from the first end and formed to extend towards said support plate;
one or more springs extending between said support plate and said mounting plate; and
a resilient cushioning material between and adhering to said support plate and said mounting plate, said resilient cushioning material surrounding at least said one or more springs.

2. The cushion of claim 1 wherein said resilient cushioning material surrounds at least the second end of said mounting plate.

3. The cushion of claim 1 wherein said mounting plate has one or more holes therethrough proximate the second end thereof, and wherein said resilient cushioning material substantially fills the holes through said mounting plate.

4. The cushion of claim 1 wherein said support plate, said mounting plate, or both includes one or more locating features for locating respective ends of said one or more springs.

5. The cushion of claim 1 wherein said mounting plate has one or more holes proximate the first end thereof for receiving a scraper blade.

6. The cushion of claim 1 wherein said resilient cushioning material includes:
a rubber; or
a plastic; or
an EPDM rubber; or
an EPDM rubber having a 60 durometer Shore A hardness.

7. The cushion of claim 1 wherein said one or more springs includes two springs each having one end located by a locating feature of said mounting plate and a second end located by a locating feature of said support plate.

8. A cushion for a scraper blade comprising:
a support plate having one or more threaded members extending from a first side thereof for engaging a support;
a mounting plate opposite a second side of said support plate, said mounting plate having a first end to which a scraper blade is mountable and having a second end remote from the first end and formed to extend towards said support plate; and
a resilient cushioning material between and adhering to said support plate and said mounting plate, said resilient cushioning material surrounding at least the formed second end of said mounting plate.

9. The cushion of claim 8 wherein said mounting plate has one or more holes therethrough proximate the second end thereof, and wherein said resilient cushioning material substantially fills the holes through said mounting plate.

10. The cushion of claim 8 further comprising one or more springs extending between said support plate and said mounting plate.

11. The cushion of claim 10 wherein said resilient cushioning material surrounds said one or more springs.

12. The cushion of claim 10 wherein said support plate, said mounting plate, or both includes one or more locating features for locating respective ends of said one or more springs.

13. The cushion of claim 10 wherein said one or more springs includes two springs each having one end located by a locating feature of said mounting plate and a second end located by a locating feature of said support plate.

14. The cushion of claim 8 wherein said mounting plate has one or more holes proximate the first end thereof for receiving a scraper blade.

15. The cushion of claim 8 wherein said resilient cushioning material includes:
a rubber; or
a plastic; or
an EPDM rubber; or
an EPDM rubber having a 60 durometer Shore A hardness.

16. A cushion for a scraper blade comprising:
a support plate having one or more threaded members extending from a first side thereof for engaging a support;
a mounting plate opposite a second side of said support plate, said mounting plate having a first end to which a scraper blade is mountable and having a second end remote from the first end; and
a resilient cushioning material between and adhering to said support plate and said mounting plate, said resilient cushioning material surrounding at least the second end of said mounting plate.

17. The cushion of claim 16 wherein said mounting plate has one or more holes therethrough proximate the second end thereof, and wherein said resilient cushioning material substantially fills the holes through said mounting plate.

18. The cushion of claim 16 wherein the second end remote from the first end of said mounting plate is formed to extend towards said support plate.

19. The cushion of claim 16 further comprising one or more springs extending between said support plate and said mounting plate.

20. The cushion of claim 19 wherein said resilient cushioning material surrounds said one or more springs.

21. The cushion of claim 19 wherein said support plate, said mounting plate, or both includes one or more locating features for locating respective ends of said one or more springs.

22. The cushion of claim 19 wherein said one or more springs includes two springs each having one end located by a locating feature of said mounting plate and a second end located by a locating feature of said support plate.

23. The cushion of claim 16 wherein said mounting plate has one or more holes proximate the first end thereof for receiving a scraper blade.

24. The cushion of claim 16 wherein said resilient cushioning material includes:
a rubber; or
a plastic; or
an EPDM rubber; or
an EPDM rubber having a 60 durometer Shore A hardness.

25. A cushion for a scraper blade comprising:
a support plate having one or more threaded members extending from a first side thereof for engaging a support;
a mounting plate opposite a second side of said support plate, said mounting plate having a first end to which a scraper blade is mountable and having a second end remote from the first end, wherein said mounting plate has one or more holes therethrough proximate the second end thereof; and
a resilient cushioning material between and adhering to said support plate and said mounting plate, said resilient cushioning material surrounding at least the second end of said mounting plate, and wherein said resilient cushioning material substantially fills the holes through said mounting plate.

26. The cushion of claim 25 wherein the second end of said mounting plate is formed to extend towards said support plate.

27. The cushion of claim 25 further comprising one or more springs extending between said support plate and said mounting plate.

28. The cushion of claim 27 wherein said resilient cushioning material surrounds said one or more springs.

29. The cushion of claim 27 wherein said support plate, said mounting plate, or both includes one or more locating features for locating respective ends of said one or more springs.

30. The cushion of claim 27 wherein said one or more springs includes two springs each having one end located by a locating feature of said mounting plate and a second end located by a locating feature of said support plate.

31. The cushion of claim 25 wherein said mounting plate has one or more holes proximate the first end thereof for receiving a scraper blade.

32. The cushion of claim 25 wherein said resilient cushioning material includes:
a rubber; or
a plastic; or
an EPDM rubber; or
an EPDM rubber having a 60 durometer Shore A hardness.
